(19) United States
(12) Patent Application Publication
(10) Pub. No.: US 2006/0176339 A1
(43) Pub. Date: Aug. 10, 2006

(54) Inkjet printer and method of actuating this inkjet printer

(75) Inventor: Matthijs B. Groot Wassink, Delft (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/349,950

(22) Filed: Feb. 9, 2006

(30) Foreign Application Priority Data
Feb. 10, 2005 (NL) 1028236

(51) Int. Cl. B41J 2/04

(52) U.S. Cl. 347/54

(57) ABSTRACT

An inkjet printer including an inkjet printhead containing a substantially closed duct provided with an exit opening used to eject ink drops from the duct, wherein the duct comprises two electrically conducting parts, each of which being fitted to a duct wall, these elements extending to the vicinity of the exit opening and together forming a capacitor, and the inkjet printer furthermore being fitted with a measuring device in order to determine the capacity of the capacitor.

This non-provisional application claims priority under 35 U.S.C. § 119(a) on Patent Application 1028236 filed in The Netherlands on Feb. 10, 2005, which is herein incorporated by reference.

### BACKGROUND OF THE INVENTION

The present invention relates to an inkjet printer comprising an inkjet printhead containing a substantially closed duct comprising an exit opening for ejecting ink drops from the duct. The present invention further relates to a method to be applied by an inkjet printer.

An inkjet printer of this kind is known from EP 1 378 360. The inkjet printer comprises an inkjet printhead fitted with a duct plate in which a number of parallel grooves are formed, each groove terminating in an exit opening. The duct plate is covered by a flexible plate so that the grooves form substantially closed ink ducts. A number of electro-mechanical converters (transducers) are provided on the flexible plate at the ducts so that each duct has a converter. During operation, the substantially closed duct is filled with ink. When a voltage is applied in the form of an actuation pulse across the electrodes of an electro-mechanical converter of this kind, this results in a deformation of the converter in the direction of the associated duct, so that the pressure in the duct suddenly increases. The known inkjet printhead may vary, for example, by variation in mechanical cohesion in the duct construction itself, or by variation at a certain time by actuation of adjacent converters. Furthermore, there may, for example, be variations in duct pressure, printhead temperature and ink viscosity. By measuring the electrical impedance of the entire transmission path up to the drop formation process and determining the produced effect of the actuation pulse in the duct based on this measurement, the effect of these parameters may be measured together. This may then be used to adapt the actuation pulse to ultimately produce the desired drop ejection.

In order to further improve the drop ejection of the known inkjet printer, the inventor has realised that an improvement may be achieved by locally determining the meniscus position of the ink in the duct.

### SUMMARY OF THE INVENTION

To this end, an inkjet printer has been developed, wherein the duct comprises two electrically conducting parts, where each part has been fitted against a duct wall, these parts extending to the vicinity of the exit opening and together forming a capacitor, and the inkjet printer furthermore is fitted with a measuring device in order to determine the capacity of the capacitor.

An inkjet printer according to the present invention may be used to easily determine the meniscus position of the ink in the vicinity of the exit opening by measuring the capacity. In the vicinity of the exit opening, the duct may be filled with air, ink or a mixture of air and ink. During operation, the meniscus position will be between two electrically conducting parts. Ink has a different dielectrical constant compared to air, which is why, for example, the air between the two electrically conducting parts contribute, to a lesser extent, to the value of the capacitor capacity than the ink between the two electrically conducting parts. By applying a voltage across the two electrically conducting parts, electrons will move (current). Here, the current produced depends on the value of the capacity and the applied voltage. T he capacity may be measured so that the meniscus position may be determined. It will be understood by those skilled in the art that “an electrically conducting part fitted against a duct wall” may also mean, for example, that an electrically conducting part is integrated into a duct wall.

According to one embodiment of the present invention, a nozzle plate is fitted against the inkjet printhead so that the exit opening of the duct coincides with a part of the duct (nozzle) in the nozzle plate, where the inkjet printer comprises an electrical connection between the capacitor and the measuring device, with at least a part of the connection being located between the nozzle plate and the inkjet printhead. When an ink drop is ejected, ink may undesirably stick to the outside of the inkjet printhead on the nozzle plate, causing the outside of the nozzle plate to become contaminated with ink. An unprotected electrical connection between the capacitor and the measuring device across the outside of the inkjet printhead and the nozzle plate, where the outside is humid due to undesired ink, has an undesirable effect on the capacity measured, so that the meniscus position cannot be determined accurately. By integrating the electrical connection in a well-screened state into the embodiment of the inkjet printhead, the measurement of the capacity is not distorted.

With an inkjet printer according to the present invention, a method may be applied utilizing an inkjet printhead containing a substantially closed duct containing an exit opening, said duct being essentially filled with ink, where a meniscus of the ink is located in the vicinity of the exit opening and the duct is fitted with two electrically conducting parts. Each electrically conducting part is fitted against a duct wall, said electrically conducting parts extending to the vicinity of the exit opening and together forming a capacitor. The method comprises: determining the capacity of the capacitor and determining the meniscus position based on the capacity. A voltage applied across the two electrically conducting parts produces an electron current that is dependent on the capacity and the voltage. This capacity may be determined if the voltage and the current are known. This makes it possible to quickly and accurately determine the meniscus position of the ink in the vicinity of the exit opening at any specific moment. For example, it may be used to determine whether a minimum or maximum fill level of the ink in the duct has been reached as required to enable an ink drop to be formed during ejection, or whether the meniscus is located in an area that is suitable to be able to eject an ink drop. Here, the minimum and maximum fill levels of the ink may be expressed in a minimum and a maximum capacity. If there is insufficient ink in the duct, it is, for example, necessary to wait until the ink has sufficiently filled the duct, after which an ink drop may be ejected from the exit opening. The value of the capacity is a direct representation of the meniscus position and may therefore be easily converted based on a model that determines the correlation between the capacity value and the meniscus position.

Another embodiment of the present method comprises imposing an actuation pulse on an actuator which is operationally connected to the duct so that an ink drop is ejected from the exit opening, and determining a variation of the meniscus position as a result of the actuation pulse. This method may be used to determine the meniscus position at various moments in time to be able to quickly and accurately determine a variation in the position. Thus, the variation of the meniscus position may be determined for the period when, for example, a drop is formed in the duct and the ink stabilises in the duct after the drop has formed. An advantage is that the variation of the meniscus position may be used to, for example, determine whether the ink is sufficiently at rest to be able to eject an ink drop. If the ink has insufficiently reached a rest state, it is possible, for example, to wait until this has been reached.

Another embodiment of the present invention comprises: modifying the actuation pulse mentioned based on the variation. In other words, the variation of the meniscus position is measured during the application of the actuation pulse, so that the effect of this pulse may be determined simultaneously with its application (in real-time). In this manner, it is possible to adapt the pulse during the application thereof, if necessary, in order to achieve a desired variation of the meniscus position in order to produce correct drop formation. If, for example, it appears at the start of the pulse that the meniscus position is increasing much too quickly in the direction of the exit opening, for whatever reason, the pulse may be modified by adjusting it in its further course based on this information. Another example is that if the ink in the duct has insufficiently reached a rest state, the pulse, and therefore also the ink, may be actively influenced so that the ink reaches a sufficient rest state faster.

Another embodiment according to the present invention comprises modifying another actuation pulse based on the variation. In other words, the variation of the meniscus position is measured and, based on this data, the actuation pulse may be modified before the next ink drop, for example to achieve improved drop formation. The advantage of this method compared to the previous embodiment is that this leaves more time to carry out complex calculations. If, for example, it appears at the start of the pulse that the meniscus position is increasing much too quickly in the direction of the exit opening, for whatever reason, the next pulse may be modified by adjusting it in its further course based on this information. Another example is that if the ink in the duct has insufficiently quickly reached a rest state, the next pulse may actively influence the ink, so that it reaches a sufficient rest state faster.

Another embodiment of the present invention comprises comparing the variation to a reference variation. A reference variation is a variation of the meniscus position that results in a certain objective being achieved. A reference variation may be predetermined, for example, in a special test arrangement. For example, a reference variation may be determined for a drop ejection with the objective of achieving a desired drop size and a desired drop speed. Thus various reference variations, for example, may be determined, each for different objectives. One particular objective may be, for example, to quickly achieve a rest state for the ink in the duct after a drop has been ejected, to compensate for cross-talk in an adjacent duct, to achieve a specific drop size at drop ejection and a specific drop speed at drop ejection. The reference variation may be stored in the inkjet printer according to the present invention, after which this reference variation is compared to the actual variation during operation. When comparing the data, a discrepancy may be detected between the actual variation and the reference variation. A discrepancy could, for example, be caused by an air bubble in the duct, partial clogging of the ink, or another dynamic behaviour in the ink-filled duct caused by ageing of the inkjet printhead. The measured variation of the meniscus position will normally follow a fixed pattern. An air bubble anywhere in the duct may be detected by the existence of a specific discrepancy between the measured variation of the meniscus position and its reference variation. If there is an air bubble in the duct, the printing process is, for example, interrupted until the air bubble has dissolved, after which an ink drop may be ejected from the exit opening, or a pressure pulse may, for example, be imposed on the actuator in between two print passes, i.e., at a carriage return, so that the air bubble is expelled from the exit opening.

Another embodiment of the present invention comprises a feedforward controller known as ILC (Iterative Learning Control) actuation technology. This control technology allows for optimum actuation pulses to be systematically generated with which preset objectives may be achieved. This method may be used to quickly and accurately determine the meniscus position at various moments in time, and thus also a variation of the position, for example for the period when a drop is formed in the duct and for the period when the ink stabilises in the duct after the drop has formed. ILC actuation technology compares the variation to a reference variation (a variation of the meniscus position that results in a specific objective being achieved) and modifies an actuation pulse so that the discrepancy between the actual variation and the reference variation is eliminated. ILC actuation technology is suitable for modifying repetitive similar tasks to a predetermined objective: to achieve higher jet frequencies, to eliminate cross-talk, to compensate for changed dynamics or to enable drop size modulation. This ILC actuation technology has the extra advantage that it is less calculation intensive compared to feedback control technology.

By applying the method in an inkjet printer according to the present invention, it is possible to take the effects of printhead ageing into account so that there is no more noticeable effect on the drop ejection. Any effect that ageing has on the drop ejection process may be corrected by application of this method. For example, if wear of the printhead leads to a deviant variation of the meniscus position, then the actuation pulse may be modified so that the correct variation of the meniscus position is achieved. A deviant variation of the meniscus position could occur, such as for example, reduction of the expansion of the converter in response to a given pulse, wear of the exit opening, weakening of the flexible plate, cracks in the printhead, or loosening of connections, etc. The compensation of the effects of ageing may be effected by updating each actuation pulse, or by measuring the effects of ageing at certain times, for example, during a service call, and modifying the actuation pulse to said measurement. The latter embodiment is easy to implement and is often sufficient if the printhead is not ageing quickly.

The jetting frequency may be made much higher using the method in an inkjet printer according to the present invention. By modifying the actuation pulse, the meniscus movement may be more quickly brought to rest at the desired meniscus position. For example, by forming the actuation pulse after the drop ejection in such a manner that it yields a pressure wave opposed to the pressure wave of the kind passing through the ducts, the damping may take place in a much shorter time so that the meniscus position is at rest in a short time and at the correct location. As a result, the next actuation pulse may be provided more quickly while maintaining good drop properties. It is also possible to let the next actuation pulse take place in any manner whatsoever, i.e., without a distinctly active damping, after a prior drop ejection and actively correct the variation of the meniscus position.

Cross-talk, i.e., the influencing of the drop ejection process in one duct by the actuation of another duct, may also be readily obviated by application of the method in an inkjet printer according to the present invention. If actuation of a transducer in one duct has an effect on the state in an adjacent duct, the effect on the meniscus position in the adjacent duct may be measured and corrected by modifying the actuation pulse according to the present invention.

Drop size modulation may be achieved by directly relating drop properties to the variation of the ink position over time. By storing the corresponding desired meniscus variation for a number of desired drop volumes (drop sizes), these profiles become available for the actuation algorithm of the transducer. If, for example, a specific drop size is required, the associated reference variation may be used with which the actuation pulse is modified so that the desired meniscus variation is achieved.

Furthermore, it is possible to vary not only the drop volume in the manner shown, but also other drop properties such as the speed. An expansion on this is possible with a model describing the transfer between the drop properties and the meniscus movement. By varying the meniscus movement over a whole range of movements and measuring the drop properties, such as the speed and drop size, at each movement, a model of the transfer may be determined. Based on this model, the actuation algorithm itself may be used to calculate the reference variation of the meniscus position given a certain objective such as a specific drop size and speed, use them as a reference variation and the variation will converge accordingly.

### BRIEF DESCRIPTION OF THE DRAWINGS

The present invention will now be further explained with reference to the following figures and examples in which specific embodiments of the present invention are outlined.

FIG. 1A is a diagram showing a cross-section of a capacitor in the inkjet printer duct.

FIG. 1B is a diagram showing a cross-section of a capacitor in the duct filled with ink.

FIG. 1C is a diagram showing a side view of a capacitor in the duct.

FIG. 2A is a diagram showing a charge amplifier.

FIG. 2B is a diagram showing a measuring device used to determine a capacity of the capacitor.

FIG. 3 is a diagram showing an electrical equivalent of the method of actuating an inkjet printhead according to the invention.

FIG. 4A is a diagram showing ILC actuation technology.

FIG. 4B is a diagram showing another example of an actuation technology.

FIG. 5 is a diagram showing an inkjet printer according to the invention.

FIG. 6A is an example showing two electrically conducting parts in a duct.

FIG. 6B is an example showing a nozzle shape.

FIG. 7A-C is an example showing a physical model of an embodiment.

### DETAILED DESCRIPTION OF THE INVENTION

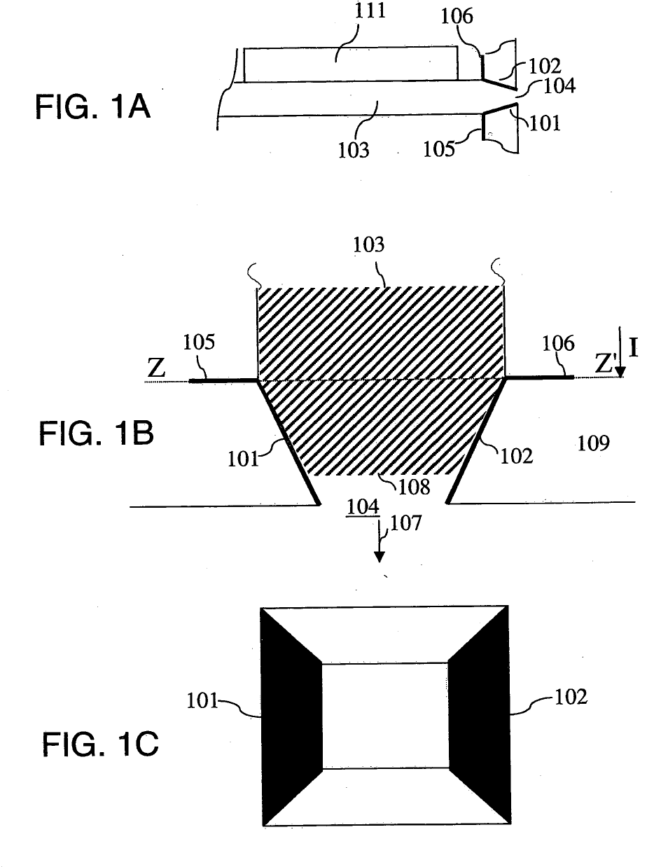

FIG. 1A is an example showing a part of the inkjet printhead according to the present invention, i.e., a cross-section of a substantially closed duct 103 and an exit opening 104 used to eject an inkjet drop from the duct. The duct comprises two electrically conducting parts (electrodes), each of which being fitted to a duct wall, indicated by 101 and 102. These parts extend to the exit opening and have such an effect on each other that they possibly cause charge accumulation to occur on the parts so that they together form a capacitor. An electrical connection, 105, 106 i.e., wiring may be used between the capacitor and the measuring device to measure the capacitor. In order to eject an inkjet drop from the duct, an actuation pulse is imposed on the transducer 111 causing the transducer to expand in the direction of the duct 103 and producing a pressure wave so that an inkjet drop is ejected from the duct.

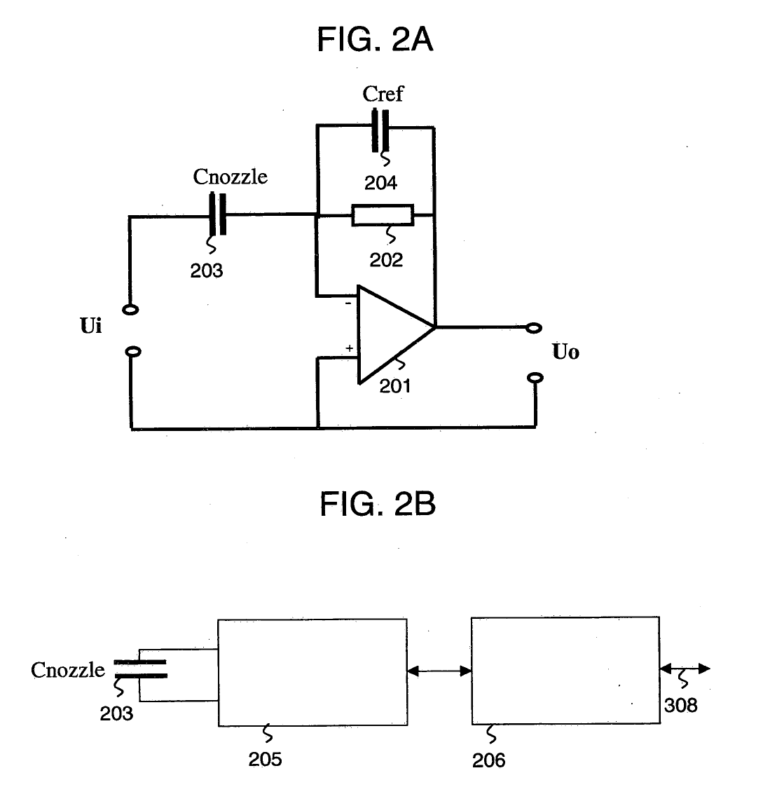

FIG. 1B shows an example of a part of a substantially closed duct 103 comprising an exit opening 104 used to eject inkjet drops from the duct. The duct comprises two electrically conducting parts electrodes, each being fitted to a duct wall, indicated by 101 and 102. These parts extend to the exit opening and have such an effect on each other that they possibly cause a charge accumulation to occur on the arts by a voltage across the elements so that they together form a capacitor. This capacitor is also indicated by 203 in FIG. 2B. The parts extend in such a manner that the ink meniscus is between the electrically conduction parts while in operation. The electrically conducting parts may, for example, be embodied in aluminium. The parts extend to the vicinity of the exit opening so that the meniscus position may be measured.

According to one embodiment, the exit opening 104 of the duct coincides with the exit opening of a nozzle in a nozzle plate. FIG. 1B shows a part of the nozzle plate 109. A nozzle plate may, for example, be a plate of a non-conducting substrate, such as silicon with an approximate thickness of between about 25 and 150 micrometers. The nozzle plate is fitted against the exit of the ducts so that the duct and the nozzle plate together comprise an exit opening 104.

To measure the capacitor, an electrical connection 105, 106 (wiring) runs between the capacitor and the measuring device, for at least a part of the connection between the nozzle plate and the inkjet printhead or along the outside (not shown) of the inkjet printhead. A disadvantage of an electrical connection running along the outside of the inkjet printhead across the nozzle plate is that any ink drop disposed on the electrical connection can produce a distorting signal when determining the capacity of the capacitor. It is preferable for the electrical connection between the capacitor and the measuring device to run at least partially between the nozzle plate and the inkjet printhead, so that a distorted signal is not produced.

FIG. 1B shows the duct of the inkjet printhead filled with ink as indicated by shading, where the direction of the ink drop ejection is indicated by 107. The instantaneous meniscus position indicated by 108 may be determined using the capacitor. During an actuation cycle, the meniscus may be slightly convex, concave or flat, which may be taken into account when determining the meniscus position.

FIG. 1C shows a cross-sectional view in the direction of the arrow (↓) from the level of the dotted line z-z′ in FIG. 1B. FIG. 1C shows an example of a capacitor in the nozzle. According to this embodiment, the duct walls up to the exit opening are tapered. FIG. 1C is a diagram showing the two electrically conducting parts indicated by a dark section 101, 102. It should be understood that in another possible embodiment of the duct, a capacitor may also be applied near the exit opening.

The following formula defines capacitor capacity C near the exit opening when it is fully filled with ink:

$$C = \frac{{ɛ}_{o} {ɛ}_{r} {A}_{eff}}{{r}_{eff}} = \frac{Q}{V} \qquad ( Formula 1 )$$

In formula 1, eₒ is the dielectrical constant in vacuum, eᵣ is the relative dielectrical constant of the ink, A_{eff} (is Aᵣₘₛ) is the surface that contributes to the capacity, r_{eff} (is rᵣₘₛ) is the distance between the parts, which contributes to the capacity, Q is the charge stored on the conducting parts and V the voltage applied between the conducting parts. Distance r_{eff} (is rᵣₘₛ) and surface A_{eff} (is Aᵣₘₛ) depend on the construction of the parts and their values may be calculated if the construction is known.

The capacity of the capacitor depends on an actual meniscus position of the ink near the exit opening. For example, this may be because the ink has a stronger dielectrical property than air. As a result, the part that is filled with ink between the two electrically conducting parts will contribute more to the capacity than the part that is filled with air.

For one embodiment of the capacitor, a model may be derived that shows a correlation between a capacitor capacity C_{nozzle} and a meniscus position xₘₑₙ. This model may, for example, be a physical model or a measured model that is determined by measurements carried out on this embodiment. By using, for example, a laser vibrometer, the meniscus position may be determined accurately. At the same time, the capacity may be determined using a measuring device. By combining the data from the two measurements, a measured model may be determined. A physical model may be derived for a concrete embodiment of the capacitor near an exit opening. The physical model may be simplified, for example, as the effect of air on the value of the capacitor capacity (dielectrical constant) may be much smaller than the effect of the ink on the capacity of the capacitor. The effect of air on the value of the capacity may therefore be neglected in some cases.

FIG. 2B is a diagram showing that the capacitor 203 is connected to a measuring device 205 to determine a capacitor capacity C_{nozzle}. According to another embodiment, the measuring device may be connected to a model module 206 in order to determine the meniscus position. The correlation between the measured capacitor capacity C_{nozzle} and the meniscus position of the ink near the exit opening to be determined is to be found in the model module.

The capacity may be determined in various ways. One way of determining the meniscus position is that during inkjet printhead operation, a constant voltage V is present across both parts and as such, also a certain charge Q is provided on the parts. Any movement of the meniscus position leads to a change in the capacity by a change in charge Q with current I, differentiated over time as shown in formula 1:

$$\frac{\partial C}{\partial t} = \frac{\partial Q / \partial t}{V} = \frac{I}{V} \qquad ( Formula 1 )$$

Current I may be measured using a measuring device, for example, one containing a ‘charge amplifier’. A disadvantage of this method is that determining the initial meniscus position i.e., a static meniscus position, is too complicated and may lead to a larger measurement error.

It would be better to use another method for determining the meniscus position. FIG. 2A shows an example of a measuring device in the form of a basic electronic diagram with which the instantaneous capacitor capacity, indicated by C_{nozzle} 203, may be determined. In this diagram, a reference capacitor C_{ref} (204), a large enough resistor R 202 and an op-amp 201) (differential amplifier) with amplification factor Aₒ and a tilt frequency τᵥ are used. The basic diagram may be modified, for example, to suppress noise and to compensate for parasitic capacities.

An alternating current is applied at the input of the measuring device, indicated by Uᵢ, after which the voltage at the output of the measuring device is measured, indicated by Uₒ. The output voltage is compared to the input voltage in order to determine capacity C_{nozzle}. The following formula applies for the transfer between the input voltage and the output voltage:

$$Uo = \frac{- j ω CnozzleR}{( j ω CrefR + 1 ) ( j ω \frac{{τ}_{v}}{Ao} + 1 )} * Ui \qquad ( Formula 8 )$$

where ω equals 2*pi*frequency, where frequency is the frequency of input signal Uᵢ. For a large enough resistor R and a jωτᵥ/Aₒ much smaller than 1, the effect of both may be neglected in the transfer, so that a simple transfer remains:

$$Uo \approx \frac{- Cnozzle}{Cref} * Ui \qquad ( Formula 9 )$$

As reference capacity C_{ref} and the input voltage are known, capacity C_{nozzle} may be easily determined by measuring the output voltage.

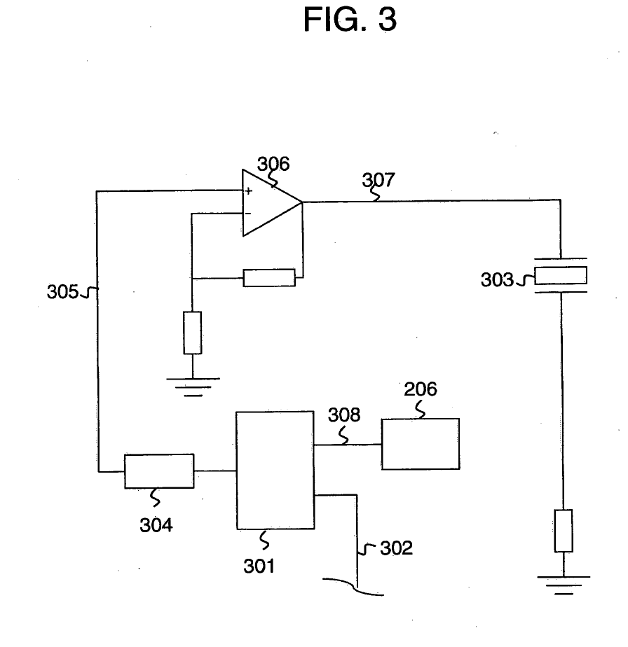

FIG. 3 shows an electrical equivalent of the method of actuating an inkjet printer according to the present invention. The electrical diagram applies for both types of controller, i.e., feedforward and feedback. The central unit in the diagram is processor (301). Within the processor 301, both types of control diagram may be used. This processor is either given a reference position or a reference variation via connection 302. The processor 301 receives the measured meniscus position of the ink near the exit opening of the model module 206 via connection 308. The variation of the meniscus position as a result of the actuation pulse may be determined by determining and storing the meniscus position at various times or continuously. This variation may, for example, be stored in a memory (not shown) that is available to the processor 301. The processor determines a signal for the electro-mechanical converter 303. For this purpose, it feeds a signal to the DA converter 304, which feeds an analogous signal via connection 305 to amplifier 306. This amplifier then feeds the actuation pulse via connection 307 to the converter 303. By deducting the measured position from the reference position, the calculated error may be added to the actuation of the electro-mechanical converter 303 so that the error in the meniscus position becomes smaller. Thus, the actuation pulse mentioned may still be directly adjusted during actuation. Alternatively, by storing the variation of the meniscus position, the next actuation pulse may also be modified based on this stored variation as a result of the previous actuation pulse.

In this manner, in addition to an actuation circuit for the electromechanical converter (transducer), a measuring circuit is also formed for determining the meniscus position near the exit opening of the duct, and a control unit processor 301 is provided for modifying the actuation pulse.

In principle, each duct may be actuated, measured and controlled in this manner. According to one embodiment, one processor unit is used for many tens or even hundreds of ink ducts. The number of processors required for an inkjet printer with many hundreds of ink ducts depends, inter alia, on the computing capacity required for adequate control of the actuation pulses.

There are various alternative actuation technologies for an inkjet printer according to the present invention. The ‘Iterative Learning Control’ (ILC) actuation technology is the preferred choice, which is a feedforward actuation technology. ILC is suitable for repetitive tasks such as ejecting ink drops from an exit opening of an inkjet printer.

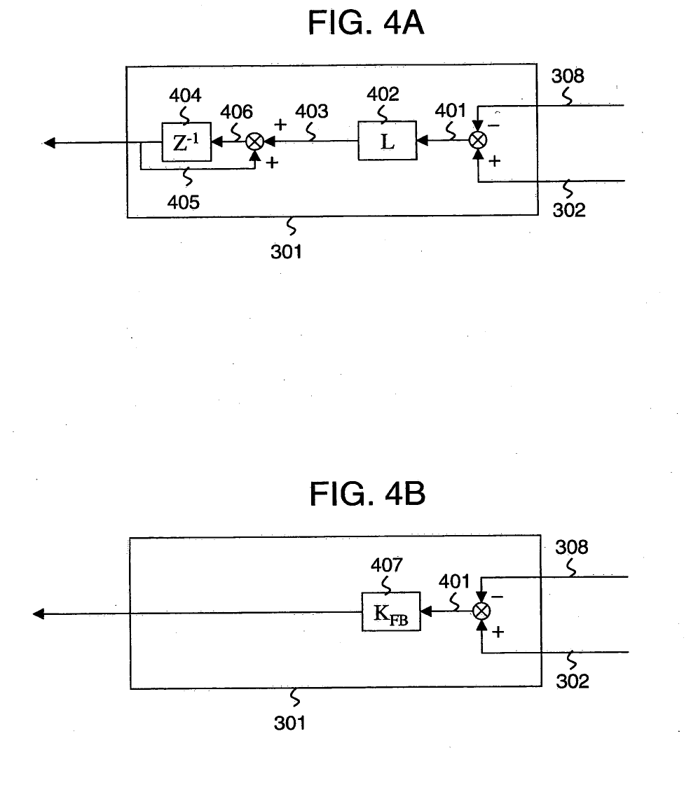

FIG. 4A is an example diagram showing ‘Lifted ILC’ control structure that may be carried out on the processor 301. The processor deducts the measured position 308 from the reference (desired) meniscus position 302. Next, the result 401, i.e. the error in the position, is multiplied by learning matrix L 402 resulting in an adaptation of the new actuation 403 compared to the previous actuation. This adaptation (403) is added to the previous actuation pulse 405 that is delayed for one attempt via operator matrix Z⁻¹ 404. This provides a new modified actuation pulse 406 for the electro-mechanical converter with which the error in the meniscus position is reduced. The deterministic error—not the stochastic error—in the position may be reduced, providing the inkjet printer has an operation area for this, to the resolution of the measuring device by performing the cycle a number of times: actuating the electro-mechanical converter, measuring the meniscus position, deducting the measured meniscus position from the reference meniscus position, multiplying the difference by learning matrix L and calculating the new modified actuation pulse.

Another alternative actuation technology is feedback actuation technology as diagrammatically illustrated in FIG. 4B. The processor 301 deducts the measured position 308 from the reference meniscus position 302. Next, the result 401, i.e. the error in the meniscus position, is used to calculate a correction for the actuation pulse in feedback controller K_{FB}, indicated by 407, leading to the current actuation being modified.

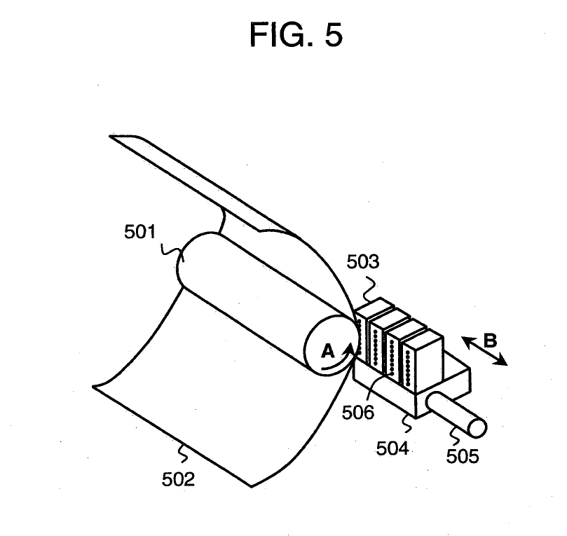

FIG. 5 is a diagram showing part of an inkjet printer. According to this embodiment, the printer comprises a roller 501 used to support a receiving medium 502 and move it along the four inkjet printheads 503. The roller 501 may rotate around its own axis as indicated by arrow A. A carriage 504 carries the four printheads 503, one for each of the colours cyan, magenta, yellow and black, and may be moved in reciprocation in a direction indicated by the double arrow B, parallel to the roller 501. In this manner, the printheads 503 may move along the receiving medium 502. The carriage 504 is guided on a rod 505 and is driven by suitable means (not shown).

According to the embodiment as shown in FIG. 5, each printhead 503 comprises eight ink ducts, each with its own exit opening 506, which form an imaginary line perpendicular to the axis of the roller 501. According to a practical embodiment of a printing device, the number of ink ducts per printhead 503 is many times greater. Each ink duct is provided with a transducer, a measuring device to determine the capacitor capacity (not shown) according to the present invention. Each printhead may also contain a control unit: an associated actuation and measuring circuit (not shown) according to FIG. 3 for modifying the actuation pulses. In this manner, the ink duct, transducer, actuation circuit and measuring device form a system serving to eject ink drops in the direction of the roller 501. However, it is not essential for all of the elements of the actuation and measuring device to be physically incorporated in the printheads 503. It is also possible for some parts to be located, for example, in the carriage 504 or even a more remote part of the printer, there being connections to components in the printheads 503 themselves. In this manner, these parts nevertheless form a functional part of the printheads without actually being physically incorporated therein. If the converters are actuated image-wise, an image built up of individual ink drops is formed on the receiving medium 502.

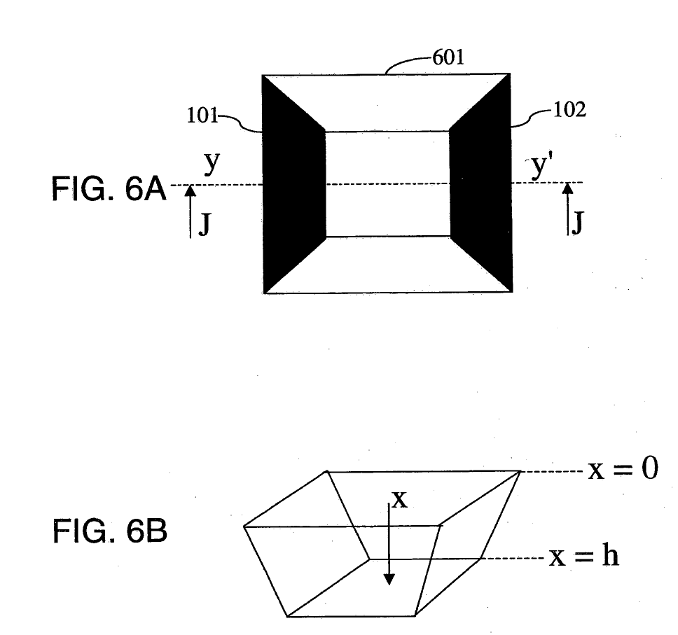

Below, an example is shown of a physical model of an embodiment of the capacitor. FIG. 6A shows a view in the direction of arrow ↓ from FIG. 1B on a cross-section taken along dotted line z-z′. In here, a capacitor is shown. The electrically conducting parts in this embodiment do not run in parallel, but as the duct walls in the nozzle up to the exit openings are tapered, the electrically conducting parts are tapered. The two electrically conducting parts are indicated by the dark mark-up 101, 102. In a side view, the duct nozzle of this embodiment looks like the diagram as shown in FIG. 6B. The height of the nozzle is equal to h. During operation, the meniscus may be between these two positions. The one end of the two electrically conducting parts starts at position x=0 and the other end of the parts ends at position x=h. According to this embodiment, the sectional plane of the nozzle is square and the one in the direction of the exit opening continues to decrease in size (is tapered). The duct walls of the nozzle follow the same shape. The angles of the nozzle shape in this embodiment are determined by the crystalline angles of the silicon.

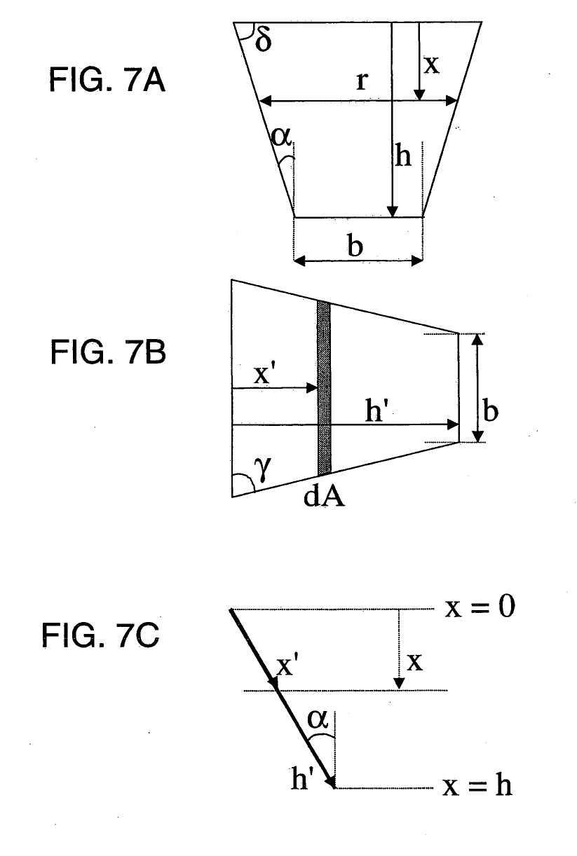

FIG. 7A shows a view in the direction indicated by the two arrows J-J in FIG. 6A on a cross-section of a duct wall 601 taken along dotted line y-y′. Arrow r in FIG. 7A indicates the width of the duct wall. According to one embodiment, the angles are equal to the silicon crystalline angles, indicated by α=35.3 degrees and δ=54.7 degrees, respectively. According to one embodiment, height h is 123*10⁻⁶ meters. The width of a duct wall in the exit opening is 25*10⁻⁶ meters. The following formula applies for distance r that depends on position x:

$$r = b + 2 \frac{( h + x )}{tan ( δ )} \qquad ( Formula 2 )$$

FIG. 7C shows a side view on an electrically conducting part (101 or 102), where the one end starts at position x=0 and the other end of this part ends at position x=h. The silicon crystalline angle is indicated as α=35.3 degrees. The length of the electrically conducting part is indicated as h′. Where:

$$( {h}^{′} - {x}^{′} ) = \frac{( h - x )}{cos ( α )} \qquad ( Formula 3 )$$

FIG. 7B shows an electrically conducting part from FIG. 6A (101 or 102) from a particular viewpoint perpendicular to the part. The length of the electrically conducting part is indicated as h′, the width of the electrically conducting part in the exit opening as b, and the position of an infinitely small electrically conducting surface d_{A} as x′. According to one embodiment, this width b is 25*10⁻⁶ meters. Two angles of each of the 4 duct walls of the nozzle are, gaccording to one embodiment, γ=60 degrees. The following formula applies for an infinitely small surface d_{A} at position x:

$$dA = b + 2 \frac{{h}^{′} - {x}^{′}}{tan ( γ )} {dx}^{′} \qquad ( Formula 4 )$$

Based on this data from one embodiment, a physical model may be derived for capacity value C_{nozzle} depending on the meniscus position where:

$${C}_{nozzle} ( {x}_{men} ) \approx {ɛ}_{0} {ɛ}_{r} {\int }_{o}^{{x}_{men}} \frac{ⅆ A}{r} \qquad ( Formula 5 )$$

In Formula 5, eₒ is the dielectrical constant in vacuum, eᵣ is the relative dielectrical constant of the ink, dA is an infinitely small electrically conducting surface at position x with a width r that contributes to the capacity, and r is the distance between the parts at position x that contributes to the capacity. In formula 5, the effect of the air-part between the electrically conducting parts on the value of the capacity has been neglected. In formula 5, position x is integrated from the zero position up to meniscus position xₘₑₙ in order to determine capacity value C_{nozzle}. When surface d_{A} (formula 4) and distance r (formula 6) are expressed in position x, height h and the construction angles of the nozzle in formula 5, this provides the following formula 6 for the derived physical model:

$${C}_{nozzle} ( {x}_{men} ) \approx {ɛ}_{o} {ɛ}_{r} {\int }_{o}^{{x}_{men}} \frac{b + 2 \frac{\frac{h - x}{cos ( α )}}{tan ( γ )}}{b + 2 \frac{h - x}{tan ( δ )}} ⅆ x \qquad ( Formula 6 )$$

This provides a physical model showing a correlation between meniscus position xₘₑₙ and capacity value C_{nozzle}.

It will be understood by those skilled in the art that one embodiment of the capacitor for determining the meniscus position may, for example but not exclusively, be achieved as follows: manufacturing steps such as applying electrodes via micro-manipulation or micro-mechanical technologies, by applying and then drying electrodes of conducting pastes, or generally known IC manufacturing steps by application of part steps such as Reactive Ion Etching and Chemical Vapour Deposition.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An inkjet printer comprising an inkjet printhead containing a substantially closed duct provided with an exit opening used to eject ink drops from the duct, wherein the duct comprises two electrically conducting parts, each of which being fitted to a duct wall, these parts extending to the vicinity of the exit opening and together forming a capacitor, and the inkjet printer further being provided with a measuring device in order to determine the capacity of the capacitor.

2. The inkjet printer according to claim 1, where a nozzle plate is fitted against the inkjet printhead so that the exit opening of the duct coincides with a nozzle in the nozzle plate, wherein the inkjet printer comprises an electrical connection between the capacitor and the measuring device, at least a part of the connection being located between the nozzle plate and the inkjet printhead.

3. A method to be applied in an inkjet printer including an inkjet printhead containing a substantially closed duct provided with an exit opening, said duct being essentially filled with ink, where a meniscus of the ink is located in the vicinity of the exit opening, and the duct contains two electrically conducting parts, each part being fitted against a duct wall, said parts extending to the vicinity of the exit opening and together forming a capacitor,
the method comprising:
determining a capacity of the capacitor, and
determining the meniscus position based on said capacity.

4. The method according to claim 3, which further comprises:
imposing an actuation pulse on an actuator being operationally connected to the duct so that an ink drop is ejected from the exit opening, and
determining a variation of the meniscus position as a result of the actuation pulse.

5. The method according to claim 4, which further comprises:
modifying said actuation pulse based on the variation.

6. The method according to claim 4 which further comprises:
modifying another actuation pulse based on the variation.

7. The method according to claim 4, which further comprises:
comparing the variation to a reference variation.

8. The method according to claim 5, where the actuation pulse is modified using a form of ILC actuation technology.
